(19) United States
(12) Patent Application Publication
(10) Pub. No.: US 2020/0356682 A1
(43) Pub. Date: Nov. 12, 2020

(54) METHOD, A SYSTEM, A DEVICE AND A READABLE MEDIUM FOR SETTING ACCESS PERMISSION FOR AN APPLICATION

(71) Applicant: SHANGHAI ZHANGMEN SCIENCE AND TECHNOLOGY CO., LTD., ShanghaiI (CN)

(72) Inventor: Zhengxiang GU, ShanghaiI (CN)

(21) Appl. No.: 16/937,596

(22) Filed: Jul. 24, 2020

Related U.S. Application Data
(63) Continuation of application No. PCT/CN2019/073173, filed on Jan. 25, 2019.

(30) Foreign Application Priority Data
Jan. 25, 2018 (CN) 201810072371.9

(51) Int. Cl. G06F 21/60; G06F 21/62

(52) U.S. Cl. CPC G06F 21/604; G06F 2221/2141; G06F 21/6209

(57) ABSTRACT

The present application provides a method, a device, a system and a readable medium for setting access permission for an application. The method comprises: obtaining an access permission configuration request from the application, and the access permission configuration request comprises an application identifier; determining at least one access permission setting policy for the application according to the access permission configuration request from the application; and setting the access permission for the application according to the at least one access permission setting policy. Recommended permission setting schemes are provided for a user according to the access permission configuration request from the application, and the access permission for the application is set by one click according to a scheme selected by the user, which simplifies user's operations and thus improves user experience.

### CROSS REFERENCE TO THE RELATED APPLICATION

This application is the continuation application of International Application No. PCT/CN2019/073173, filed on Jan. 25, 2019, which is based upon and claims priority to Chinese Patent Application No. 201810072371.9, filed on Jan. 25, 2018, the entire contents of which are incorporated herein by reference.

### FIELD

The present application relates to computer data processing technologies, and more relates to a method, a system, a device and a readable medium for setting access permission for an application.

### BACKGROUND

In a terminal device system, applications of different types, when installed or used, will send a large number of access permission configuration requests to the system. Generally, the system allows a user to select and set the required access permission in form of a pop-up window. Too many or too frequent permission requests from some applications lead to too many user operations of setting access permission, which will degrade convenience of use experience of a user.

### SUMMARY

In view of this, embodiments of the present application provide a method, a system, a device and a readable medium for setting access permission for an application, which are used to solve problems in the prior art, such as too many or too frequent permission requests from some applications which lead to too many user operations of setting access permission.

An embodiment of the specification provides a method for setting access permission for an application. The method comprises:

obtaining an access permission configuration request from the application, and the access permission configuration request comprises an application identifier;

determining at least one access permission setting policy for the application according to the access permission configuration request from the application; and

setting the access permission for the application according to the at least one access permission setting policy.

In one embodiment, in the above-mentioned method, setting the access permission for the application according to the at least one access permission setting policy comprises:

determining a setting policy to be executed from the at least one access permission setting policy; and

setting the access permission for the application with the setting policy to be executed.

In one embodiment, in the above-mentioned method, the method further comprises:

reporting the setting policy to be executed to a server.

In one embodiment, in the above-mentioned method, determining the at least one access permission setting policy for the application according to the access permission configuration request from the application comprises:

transmitting a query message to the server, and the query message comprises the application identifier; and

receiving a query result returned by the server, and the query result comprises the application identifier and at least one access permission setting policy corresponding to the application identifier.

In one embodiment, in the above-mentioned method, the at least one access permission setting policy comprises at least one of the following setting policies:

minimum permission required by the application for operation;

permission for the application set by users which is obtained based on an algorithm according to big data; and

custom permission selected for the application which is backed up on the server by a user.

In one embodiment, in the above-mentioned method, the at least one access permission setting policy further comprises: custom permission selected for the application which is backed up on the server by a user.

The present application also provides a method for setting access permission for an application. The method comprises:

receiving a query message transmitted by a terminal device, and the query message comprises an application identifier;

generating, according to the application identifier, at least one access permission setting policy corresponding to the application identifier; and

transmitting the at least one access permission setting policy to the terminal device, and the terminal device performs, according to the at least one access permission setting policy, a permission setting operation on a received access permission configuration request from the application.

In one embodiment, in the above-mentioned method, the at least one access permission setting policy comprises at least one of the following setting policies:

minimum permission required by the application for operation; and

permission for the application set by users which is obtained based on an algorithm according to big data.

In one embodiment, in the above-mentioned method, the at least one access permission setting policy further comprises: custom permission selected for the application which is backed up on the server by a user.

In one embodiment, in the above-mentioned method, generating the permission for the application set by a user which is obtained based on the algorithm according to big data comprises:

obtaining configuration policies for the application by multiple terminal devices; and

generating, according to the obtained configuration policies for the application by multiple terminal devices, the permission for the application set by the user which is obtained based on the algorithm according to big data.

In one embodiment, in the above-mentioned method, generating the permission for the application set by the user which is obtained based on the algorithm according to big data further comprises: setting at least one permission level for the application according to configuration policies for the application set by multiple users.

In one embodiment, in the above-mentioned method, performing, by the terminal device according to the at least one access permission setting policy, the permission setting operation on a received access permission configuration request from the application, comprises:

determining a setting policy to be executed from the at least one access permission setting policy; and

performing, by the terminal device according to the setting policy to be executed, the permission setting operation on the received access permission configuration request from the application.

The present application further provides a device for setting access permission for an application. The device includes a memory for storing computer program instructions and a processor for executing program instructions, and the computer program instructions, when executed by the processor, trigger the device to perform the above-mentioned methods.

The present application still further provides a computer readable medium having computer readable instructions stored thereon, the computer readable instructions being executable by a processor to implement the above-mentioned methods.

The embodiments of the present application can achieve the following beneficial effects: providing recommended permission setting schemes for a user according to an access permission configuration request from an application, setting the access permission for the application by one click according to a scheme selected by the user, and thus simplifying user's operations and improving user experience.

### DESCRIPTIONS OF THE DRAWINGS

A further understanding of the present application is provided with reference to the drawings illustrated herein which constitute a part of the present application. The schematic embodiments and the illustration thereof in the present application are used to explain the present application, and are not intended to limit the present application improperly. In the drawings:

FIG. 1 is a schematic flowchart of a method for setting access permission for an application provided in an embodiment of the present application;

FIG. 2 is a schematic flowchart of a method for setting access permission for an application provided in an embodiment of the present application; and

FIG. 3 is a schematic structural diagram of a system for setting access permission for an application in an embodiment of the present application.

### DETAILED EMBODIMENTS

Embodiments of the present application will be described clearly and completely below in conjunction with corresponding drawings of the present application. The described embodiments are merely a part of the embodiments, but not all of the embodiments of the present application. Based on the embodiments in the present application.

The embodiments of the present application will be explained in detail below with reference to the drawings.

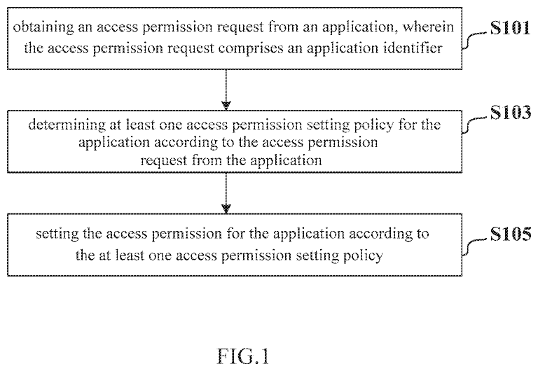

FIG. 1 is a schematic flowchart of a method for setting access permission for an application provided in an embodiment of the present application. The method may be shown as follows. The embodiment of the present application may be performed by a system program (hereinafter referred to as “a permission program”) which manages access permission for other applications. The present application is not limited in this aspect specifically. In some embodiments of the present application, the permission program may be a system program installed by default before terminal devices leave factory. In some other embodiments of the present application, the permission program may be an application program installed by a user during use of a terminal device. The user may ROOT the terminal device before installing the permission program, and authorize administrator permission to the permission program. The administrator permission may be used to manage access permission for other applications.

S101: an access permission configuration request from an application is obtained, and the access permission configuration request comprises an application identifier.

The application identifier includes but is not limited to: package name (PackageName) of the application. The package name of the application is a unique identification of the application. The application may be classified according to the package name of the application such as a system-type application, a map-type application, a social-type application, an office-type application or a gaming-type application, etc. The present application is not limited in this aspect specifically.

Further, the access permission configuration request may comprise a request for at least one of the following kinds of access permission: a permission for reading and writing, a permission for running in the background, a permission for locating, a permission for an address book, a permission for a camera, a permission for a microphone, and a permission for network connection, etc. The present application is not limited in this aspect specifically. Parts of the access permission requested by the access permission configuration request are necessarily required by the application for operation, such as a permission for locating is necessarily required by a map-type application, and a permission for reading and writing is necessarily required by an office-type application, etc. Parts of the access permission requested by the access permission configuration request are unnecessarily or maliciously required by the application for operation, such as a permission for an address book is required by an office-type application, and a permission for locating is required by a gaming-type application, etc.

S103: at least one access permission setting policy for the application is determined according to the access permission configuration request from the application.

Specifically, a terminal device initially transmits a query message to a server, and the query message comprises the application identifier. Secondly, the server generates, according to the application identifier, at least one access permission setting policy corresponding to the application identifier; and transmits a query result to the terminal device, and the query result comprises the application identifier and the at least one access permission setting policy corresponding to the application identifier. Then, after receiving the query result transmitted by the server, the terminal device determines, according to the application identifier, the at least one access permission setting policy corresponding to the application identifier from the query result.

The at least one access permission setting policy is generated by the server according to the application identifier. In some embodiments of the present application, the server may classify the application according to the package name of the application, and generate an access permission setting policy for the application according to classification information on the application. For example, the server may classify the application as a system-type application, a map-type application, a social-type application, an office-type application or a gaming-type application, etc. The present application is not limited in this aspect specifically. The server may generate an access permission setting policy according to classification information on the application. The access permission setting policy may comprise: setting minimum permission required by the application for operation (referred to as “a minimum permission policy”); setting permission for the application set by users which is obtained based on an algorithm according to big data (referred to as “a normal permission policy”); setting custom permission selected for the application which is backed up on the server by a user (referred to as “a custom permission policy”). The access permission setting policy may be generated by the server according to the classification information on the application and pre-stored access permission setting policy(s) for the application of same kind as the application.

Further, in some embodiments of the present application, generating, by the server, the permission for the application set by the users which is obtained based on the algorithm according to big data comprises: obtaining configuration policies for the application by multiple terminal devices by the server; generating, by the server according to the obtained configuration policies for the application by multiple terminal devices, the permission for the application set by the users which is obtained based on the algorithm according to big data. Still further, the server may also set at least one permission level for the application according to configuration policies for the application set by multiple users. When there are multiple permission levels, policies of multiple permission levels may be pushed to the terminal device for a user to select when pushing to the terminal device.

At step S105, the access permission for the application is set according to the at least one access permission setting policy.

Specifically, in an embodiment of the present application, setting the access permission for the application according to the at least one access permission setting policy comprises: determining a setting policy to be executed from the at least one access permission setting policy; and setting the access permission for the application with the setting policy to be executed.

Specifically, in an embodiment of the present application, the setting policy to be executed is determined from the at least one access permission setting policy based on a specified operation of a user.

The specified operation of the user includes but is not limited to clicking a screen of the terminal device. The setting policy to be executed is determined from the at least one access permission setting policy based on the specified operation of the user. In specific, in an embodiment of the present application, a permission policy is determined from the above-described minimum permission policy, the normal permission policy, and the custom permission policy, and the determined permission policy is the setting policy to be executed. For example, in an embodiment of the present application, if the permission policy determined from the above-described minimum permission policy, the normal permission policy, and the customized permission policy is the normal permission policy, then the setting policy to be executed is the normal permission policy.

In other embodiments of the present application, when the setting policy to be executed has not been determined from the at least one access permission setting policy by a user within some preset time, a policy is selected directly from the at least one access permission setting policy by default as the setting policy to be executed. Specifically, when there is only one access permission setting policy, the access permission setting policy selected by default is the one access permission setting policy. When a number of the access permission setting policies is greater than 1, the normal permission policy may be set as the default policy, or the minimum permission policy may be set as the default policy.

The terminal device sets the access permission for the application based on the setting policy to be executed. Continued in the above example, the permission setting policy for the application is the normal permission policy.

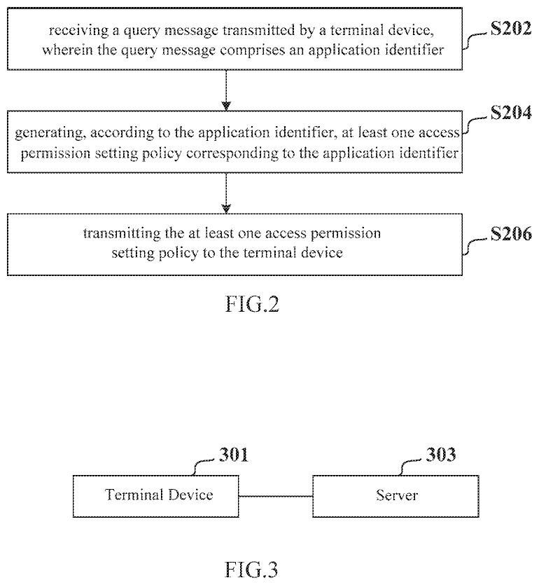

An embodiment of the present application also provides a method for setting access permission for an application as shown in FIG. 2. FIG. 2 is a schematic flowchart of a method for setting access permission for an application provided in another embodiment of the present application. The method may be shown as follows. The method for setting the access permission for the application comprises: receiving a query message transmitted by a terminal device, and the query message comprises an application identifier, as shown in step S202 in FIG. 2; generating at least one access permission setting policy corresponding to the application identifier, according to the application identifier, as shown in step S204 in FIG. 2; transmitting the at least one access permission setting policy to the terminal device, and the terminal device performs, according to the at least one access permission setting policy, a permission setting operation on a received access permission configuration request from the application, as shown in step S206 in FIG. 2.

S202: a query message transmitted by a terminal device is received, and the query message comprises an application identifier.

The query message comprises an application identifier. The application identifier includes but is not limited to: a package name (PackageName) of the application. The package name of the application is a unique identification of the application. The application may be classified according to the package name of the application such as a system-type application, a map-type application, a social-type application, an office-type application or a gaming-type application, etc. The present application is not limited in this aspect specifically.

The access permission configuration request may comprise a request for at least one of the following kinds of access permission: a permission for reading and writing, a permission for running in the background, a permission for locating, a permission for an address book, a permission for a camera, a permission for a microphone, and a permission for network connection, etc. The present application is not limited in this aspect specifically. Parts of the access permission requested by the access permission configuration request are necessarily required by the application for operation, such as a permission for locating is necessarily required by a map-type application, a permission for reading and writing is necessarily required by an office-type application, etc. Parts of the access permission requested by the access permission configuration request are unnecessarily or maliciously required by the application for operation, such as a permission for an address book is required by an office-type application, a permission for locating is required by a gaming-type application, etc.

S204: at least one access permission setting policy corresponding to the application identifier is generated according to the application identifier.

In some embodiments of the present application, the server may generate the access permission setting policy according to classification information on the application. The access permission setting policy may comprise a minimum permission policy, a normal permission policy, and a custom permission policy. For example, the minimum permission policy may comprise only a permission for reading and writing, etc.; the normal permission policy may comprise a permission for reading and writing, a permission for running in the background and a permission for network connection, etc.; the custom permission policy may comprise any permission listed by the access permission configuration request. In some embodiments, the terminal device may obtain the minimum permission policy and the normal permission policy from the server, according to the package name of the application. The terminal device may obtain the custom permission policy according to policy for the access permission for the application customized by a user in a local client. The custom permission policy may comprise an energy-saving policy, a flight policy and a privacy policy, etc. The present application is not limited in this aspect specifically. Users may add or remove permission options listed by an access permission configuration request that are allowed according to the minimum permission policy and the normal permission policy and determine it as a custom permission policy.

Further, in some embodiments of the present application, generating, by the server, the permission for the application set by the users which is obtained based on the algorithm according to big data comprises: obtaining configuration policies for the application by multiple terminal devices by the server; generating, by the server according to the obtained configuration policies for the application by multiple terminal devices, the permission for the application set by the users which is obtained based on the algorithm according to big data. Still further, the server may also set at least one permission level for the application according to configuration policies for the application set by multiple users. When there are multiple permission levels, policies of multiple permission levels may be pushed to the terminal device for a user to select when pushing to the terminal device.

S206: the at least one access permission setting policy is transmitted to the terminal device.

The server transmits the at least one generated access permission setting policy to the terminal device, and the terminal device performs, according to the at least one access permission setting policy, a permission setting operation on the received access permission configuration request from the application. In some embodiments of the present application, the terminal device may set the access permission for the application according to access permission setting policy for the application which is generated by the server. For example, the terminal device may call a permission status function (for example, GrantPermissions) in a system toolkit to change the access permission for the application.

In some embodiments of the present application, a policy is selected from the at least one access permission setting policy as the setting policy to be executed based on a specified operation of a user. Specifically, a setting policy is selected from the minimum permission policy, the normal permission policy and the custom permission policy. For example, the access permission for the application is set by one click on the terminal device after the minimum permission policy is selected. In some embodiments, if the user is not satisfied with the access permission setting policy, the user may adjust permission setting of the access permission setting policy manually.

In some embodiments of the present application, an obtaining condition for obtaining an access permission setting policy for an application may be that the policy may be obtained every other time period (for example, 1 hour) or the policy may be obtained when the access permission setting policy for the application is changed. The access permission setting policy for the application may comprise a minimum permission policy, a normal permission policy, and a custom permission policy. For example, if the normal permission policy for the application does not contain permission access to an address book and the changed normal permission policy contains permission access to the address book, then it is considered that the normal permission policy has been changed.

In some embodiments of the present application, the server may make statistics of frequency of allowance of permission listed by an access permission configuration request corresponding to historical access permission setting policies for the application; and take permission options listed by the access permission configuration request that are allowed with highest frequency as the updated access permission setting policy. In some embodiments, the minimum permission policy or the normal permission policy for an application which is recommended by the server is often changed manually by a user. In one embodiment, a user often selects a custom permission policy. For example, according to statistics of user data in a month, if the frequency of allowance of permission for access to a camera is greater than that of rejection of permission for access to the camera by a user in the normal permission policy, the normal permission policy is updated, which will add the permission for access to the camera to the normal permission policy. In another example, according to statistics of user data in a month, if frequency of selection of a same custom permission policy is higher than that of selection of any other access permission setting policy by a user, then the custom permission policy will be taken as the updated normal permission policy.

### Specific Embodiment One

In a solution of an embodiment of the present application, the server receives a package name of an application which is latest installed on the terminal device. The server determines that the application is a map-type application according to the package name. The access permission configuration policy of the application is not pre-stored in the server. An access permission configuration request from the application comprises: a permission for locating, a permission for reading and writing, a permission for running in the background, a permission for an address book, a permission for a camera, a permission for a microphone, and a permission for network connection. The server generates a minimum permission policy and a normal permission policy for the application according to a pro-stored method for setting permission policy for other map-type applications. The minimum permission policy comprises a permission for locating and a permission for network connection, and the normal permission policy comprises a permission for locating, a permission for running in the background, and a permission for network connection. The client provides the generated minimum permission policy and the generated normal permission policy to a user as permission setting policy options. After a policy is selected by the user, the terminal device sets the corresponding permissions in the access permission configuration request for the map-type application by one click.

### Specific Embodiment Two

In a solution of an embodiment of the present application, the terminal device obtains an access permission configuration request from an application which is running on the terminal device. The access permission configuration request may be a permission request for a single function. For example, the application which is running on the terminal device is a social-type application and the current access permission setting policy is a privacy policy from custom permission policies. The social-type application requests for access to an address book. The terminal device may automatically reject the permission access to the address book according to the privacy policy. The terminal device may also prompt the user to change the permission setting policy or adjust setting of permission to the address book in the privacy policy. After the permission setting policy is adjusted or the setting of permission to the address book in the privacy policy is adjusted, the server may make record of this adjustment as basis for updating the permission setting policy.

### Specific Embodiment Three

In a solution of an embodiment of the present application, the terminal device may obtain its current running state. The current running state of the terminal device may comprise: power state, memory usage rate, etc. The terminal device may set access permission for an application according to its current running state. The custom permission policy may comprise an energy-saving policy and a policy in case of out of memory. For example, for office-type applications, when power capacity is less than 20%, the access permission setting policy may be adjusted from the normal permission policy to the energy-saving policy automatically. The energy-saving policy rejects a permission for running in the background and a permission for network connection, etc.

An embodiment of the present application also provides a system for setting access permission for an application as shown in FIG. 3. FIG. 3 is a schematic structural diagram of a system for setting access permission for an application in an embodiment of the present application. The system comprises a terminal device 301 and a server 303.

The terminal device 301 transmits a query message to the server 303, and the query message comprises an application identifier; receives at least one access permission setting policy corresponding to the application identifier, which is generated by the server 303; determines a setting policy to be executed from the at least one access permission setting policy based on a specified operation of a user; and performs, according to the setting policy to be executed, a permission setting operation on the received access permission configuration request from the application.

The server 303 receives query information transmitted by the terminal device 301; generates at least one access permission setting policy corresponding to the application identifier, according to the application identifier contained in the query information; and transmits the at least one access permission setting policy to the terminal device 301.

Based on the same inventive concept, embodiments of the present application further provide a device for setting access permission for an application. The device includes a memory for storing computer program instructions and a processor for executing program instructions, and the computer program instructions, when executed by the processor, trigger the device to perform the above-mentioned methods.

Based on the same inventive concept, embodiments of the present application still further provide a computer readable medium having computer readable instructions stored thereon, the computer readable instructions being executable by a processor to implement the above mentioned methods.

A method, a system, a device and a readable medium for setting access permission for an application provided in the embodiments of the present application provides recommended permission setting schemes for a user according to the access permission configuration request from the application, and sets the access permission for the application by one click according to a scheme selected by the user, which simplifies user's operations and thus improves user experience.

The embodiments in the present application are described in a progressive manner. The identical or similar parts among the embodiments can be referred to each other, and an aspect detailed and emphasized by each embodiment is the part which is different from that in other embodiments. In particular, for the device and media embodiments, since they are basically similar to the method embodiments, the description is relatively simple, and the relevant parts can be referred to a part of the description of the method embodiments.

The devices and the media provided in the embodiments of the present application correspond to the method in a one-to-one manner.

The embodiments of the present disclosure may be provided as methods, systems, or computer program products. Therefore, the present disclosure may take the form of an embodiment entirely implemented in hardware, an embodiment entirely implemented in software, or an embodiment implemented by combining software and hardware. Moreover, the present disclosure may take the form of a computer program product implemented on one or more computer usable storage media (including but not limited to disk storage, CD-ROM, optical storage, etc.) containing computer usable program code.

The present disclosure is described with reference to flowcharts and/or block diagrams of methods, devices (systems), and computer program products according to the embodiments of the present disclosure. It should be understood that each flow and/or block in the flowchart and/or block diagram and a combination of the flow and/or block in the flowchart and/or block diagram may be implemented by computer program instructions. These computer program instructions can be provided to a processor of a general-purpose computer, a special-purpose computer, an embedded processing machine, or other programmable data processing devices to produce a machine that enables the instructions executed by the processor of the computer or other programmable data processing devices to produce an apparatus for implementing the functions specified in one flow or multiple flows of a flowchart and/or one block or multiple blocks of a block diagram.

These computer program instructions may also be stored in a computer readable memory that can direct a computer or other programmable data processing devices to work in a specific manner, so that the instructions stored in the computer readable memory produce an article of manufacture including an instruction device, and the instruction device implements the functions specified in one block or multiple blocks of a flowchart and/or one block or multiple blocks of a block diagram.

These computer program instructions can also be loaded onto a computer or other programmable data processing devices, so that a series of operating steps are performed on the computer or other programmable devices to produce computer-implemented processing, so that the instructions executed on the computer or other programmable devices provide steps for implementing the functions specified in one flow or multiple flows of a flowchart and/or one block or multiple blocks in a block diagram.

In a typical configuration, a computing device includes one or more processors (CPUs), input/output interfaces, network interfaces, and memories.

The memory may include a non-permanent memory, a random access memory (RAM) and/or a non-volatile memory and the like in a computer-readable medium, such as a read-only memory (ROM) or a flash memory (flash RAM)). A memory is an example of a computer-readable medium.

A computer-readable medium comprises permanent and non-permanent, movable and non-movable media and may implement information storage by means of any method or technology. Information may be computer-readable instructions, data structures, program modules or other data. The examples of a computer storage medium include but are not limited to a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, compact disk read-only memory (CD-ROM), a digital versatile disc (DVD) or other optical storages, a magnetic cassette tape, and magnetic tape and magnetic disk storage or other magnetic storage devices or any other non-transmission media, which can be used to store information that can be accessed by a computing device. According to the definition herein, the computer-readable medium does not include a non-transitory computer-readable medium, such as a modulated data signal and a carrier.

It should also be noted that the terms “comprise”, “include”, “contain” or any other variant thereof are intended to cover non-exclusive inclusion, so that a process, method, goods or device that includes a series of elements not only includes those elements, but also includes other elements not explicitly listed, or include elements inherent to such process, method, goods, or device. With no further restrictions, the element defined by the sentence “include a/an . . . ” does not exclude that there are other identical elements in the process, method, goods, or device that includes the element.

What is claimed is:

1. A method for setting access permission for an application comprising:
obtaining an access permission configuration request from the application, wherein the access permission configuration request comprises an application identifier;
determining at least one access permission setting policy for the application according to the access permission configuration request from the application; and
setting the access permission for the application according to the at least one access permission setting policy.

2. The method according to claim 1, wherein the setting of the access permission for the application according to the at least one access permission setting policy comprising:
determining a setting policy to be executed from the at least one access permission setting policy; and
setting the access permission for the application with the setting policy to be executed.

3. The method of claim 2, wherein the method further comprising:
reporting the setting policy to be executed to a server.

4. The method according to claim 1, wherein the determining of the at least one access permission setting policy for the application according to the access permission configuration request from the application comprising:
transmitting a query message to a server, wherein the query message comprises the application identifier; and
receiving a query result returned by the server, wherein the query result comprises the application identifier and at least one access permission setting policy corresponding to the application identifier.

5. The method according to claim 4, wherein the at least one access permission setting policy comprises at least one of the following setting policies:
minimum permission required by the application for operation;
permission for the application set by users which is obtained based on an algorithm according to big data.

6. The method according to claim 5, wherein the at least one access permission setting policy further comprises:
custom permission selected for the application which is backed up on the server by a user.

7. A method for setting access permission for an application comprising:
receiving a query message transmitted by a terminal device, wherein the query message comprises an application identifier;
generating, according to the application identifier, at least one access permission setting policy corresponding to the application identifier; and
transmitting the at least one access permission setting policy to the terminal device, and the terminal device performs, according to the at least one access permission setting policy, a permission setting operation on a received access permission configuration request from the application.

8. The method according to claim 7, wherein the at least one access permission setting policy comprises at least one of the following setting policies:
minimum permission required by the application for operation; and
permission for the application set by users which is obtained based on an algorithm according to big data.

9. The method according to claim 8, wherein the at least one access permission setting policy further comprises:
custom permission selected for the application which is backed up on the server by a user.

10. The method according to claim 8, wherein the step of generating the permission for the application set by users which is obtained based on the algorithm according to big data comprising:
obtaining configuration policies for the application by multiple terminal devices; and
generating, according to the obtained configuration policies for the application by multiple terminal devices, the permission for the application set by the users which is obtained based on the algorithm according to big data.

11. The method according to claim 10, wherein the method further comprising:
setting at least one permission level for the application according to configuration policies for the application set by multiple users.

12. The method according to claim 7, wherein the performing, by the terminal device according to the at least one access permission setting policy, the permission setting operation on a received access permission configuration request from the application comprising:
determining a setting policy to be executed from the at least one access permission setting policy; and
performing, by the terminal device according to the setting policy to be executed, the permission setting operation on the received access permission configuration request from the application.

13. A device for setting access permission for an application, the device comprising a memory for storing computer program instructions and a processor for executing program instructions, wherein the computer program instructions, when executed by the processor, trigger the device to:
obtain an access permission configuration request from the application, wherein the access permission configuration request comprises an application identifier;
determine at least one access permission setting policy for the application according to the access permission configuration request from the application; and
set the access permission for the application according to the at least one access permission setting policy.
